(19) United States
(12) Patent Application Publication
(10) Pub. No.: US 2013/0194058 A1
(43) Pub. Date: Aug. 1, 2013

(54) BACK SAVER

(71) Applicant: VALERIA DENISE FRANKLIN, PINE BLUFF, AR (US)

(72) Inventor: VALERIA DENISE FRANKLIN, PINE BLUFF, AR (US)

(21) Appl. No.: 13/645,510

(22) Filed: Apr. 4, 2013

Related U.S. Application Data
(60) Provisional application No. 61/543,589, filed on Oct. 5, 2011.

(51) Int. Cl. H01F 7/02

(52) U.S. Cl. 335/302; 414/787

(57) ABSTRACT

The invention disclosed here relates in general to a field of devices used to eliminate stress and strain to the body caused due to excessive bending and/or stooping.

The Back Saver is a device used for the purpose of eliminating stress to the back and legs due to excessive bending and/or stooping. The purpose of this devise is targeted small objects that get trapped in vacuums such as paper clips, staples, safety pins, tacks, nails, etc. This device allows these objects to be picked up using this hand held tool, which consists of a magnetic attraction.

I claim the benefit of the filing date of provisional application, No. 61/543,589 on Oct. 5, 2011.

A device used for the sole purpose of detecting small foreign objects that would normally get trapped in and clog vacuums. The sole purpose of the Back Saver is to eliminate stress to the lower body, specifically the back and legs; that is generally caused due to excessive bending and/or stooping.

In the assembling of the attachments, the Back Saver is created. This device includes preferably two extension hoses, combined to give length to the device and an attachment head which is used for the collecting of foreign objects such as paperclips, staples, safety pins, tracks, nails etc.

The attachment of two or more extension hoses, made of a hard plastic, which enables the ends to seal together creating one hose.

The attachment head consist of a hard plastic base with a magnetic head which draws and/or attracts foreign objects such as paperclips, safety pins, tacks etc.

This devise can be stored on the vacuum as a completely assembled device or separate.

This substitute specification does not contain any new matter.

### BRIEF DESCRIPTION OF DRAWINGS

The preferred attachments of the invention will hereinafter be described in conjunction with the appended drawings provided to illustrate and not to limit the invention.

FIG. 1 illustrates the complete assembly of the invention

FIG. 2 illustrates the base attachment of the invention which is preeminent to its existence.

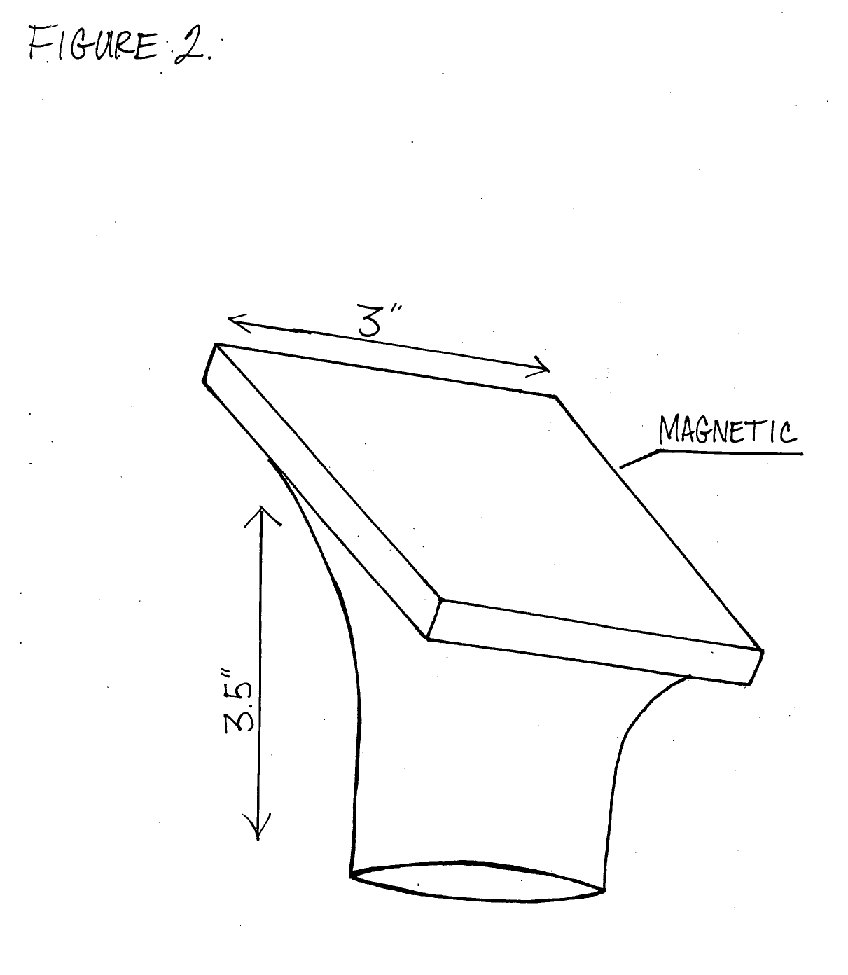

FIG. 3 illustrates the combining of two extension hoses to give length to the invention.

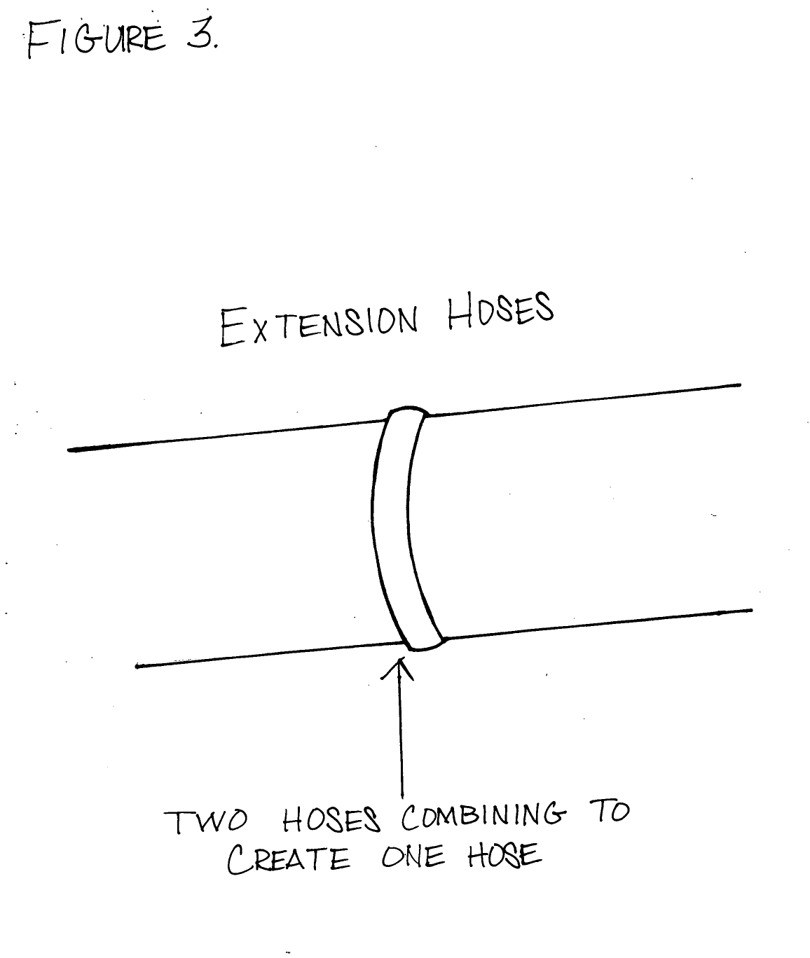

FIG. 4 illustrates all three parts of the invention.

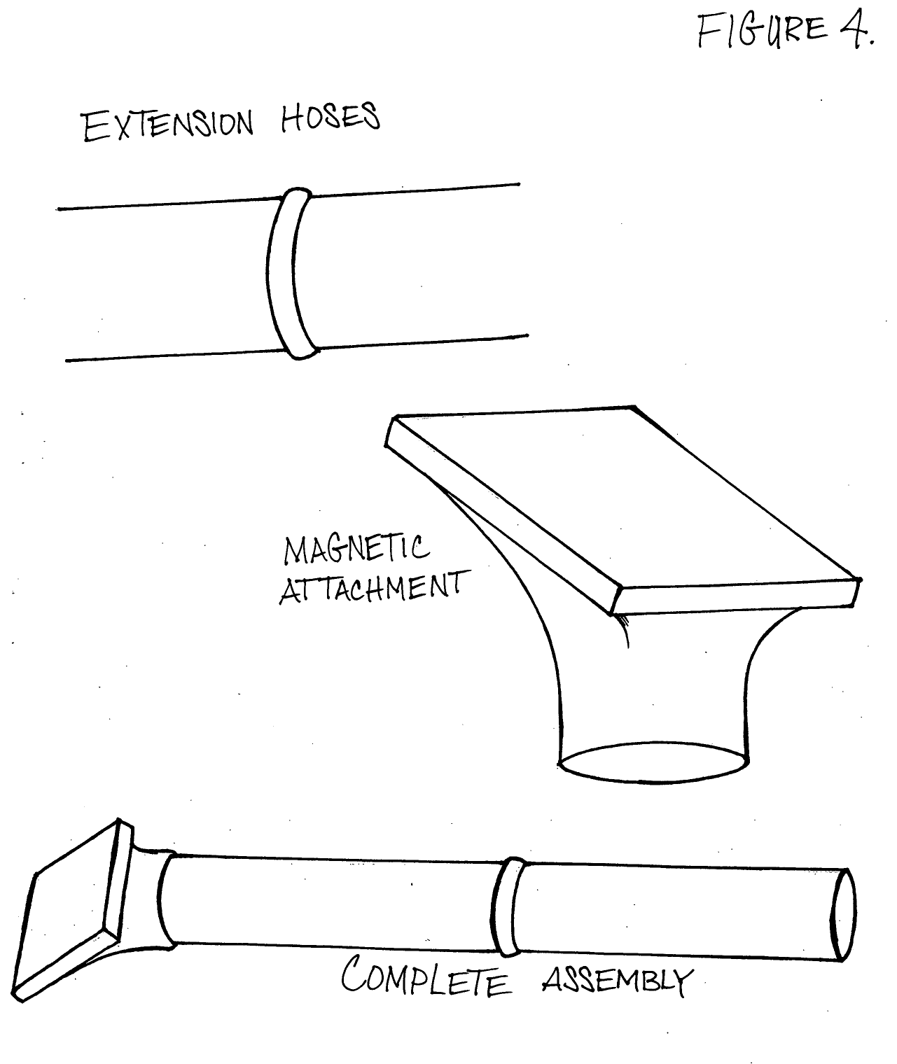

### DETAILED DESCRIPTION OF THE ATTACHMENTS

While the preferred attachments of the invention have been illustrated and described, it will be clear that the invention is not limited to these attachments only. Numerous modifications, changes, variations, substitutions, and equivalent will be apparent to those skilled in the art without parting from the spirit and scope of the invention.

In the assembling of the attachments, the Back Saver is created. This device includes preferably two extension hoses, combined to give length to the device and an attachment head which is used for the collecting of foreign objects such as paperclips, staples, safety pins, tracks, nails etc.

The attachment of two or more extension hoses, made of a hard plastic, which enables the ends to seal together creating one hose.

The attachment head consist of a hard plastic base with a magnetic head which draws and/or attracts foreign objects such as paperclips, safety pins, tacks etc.

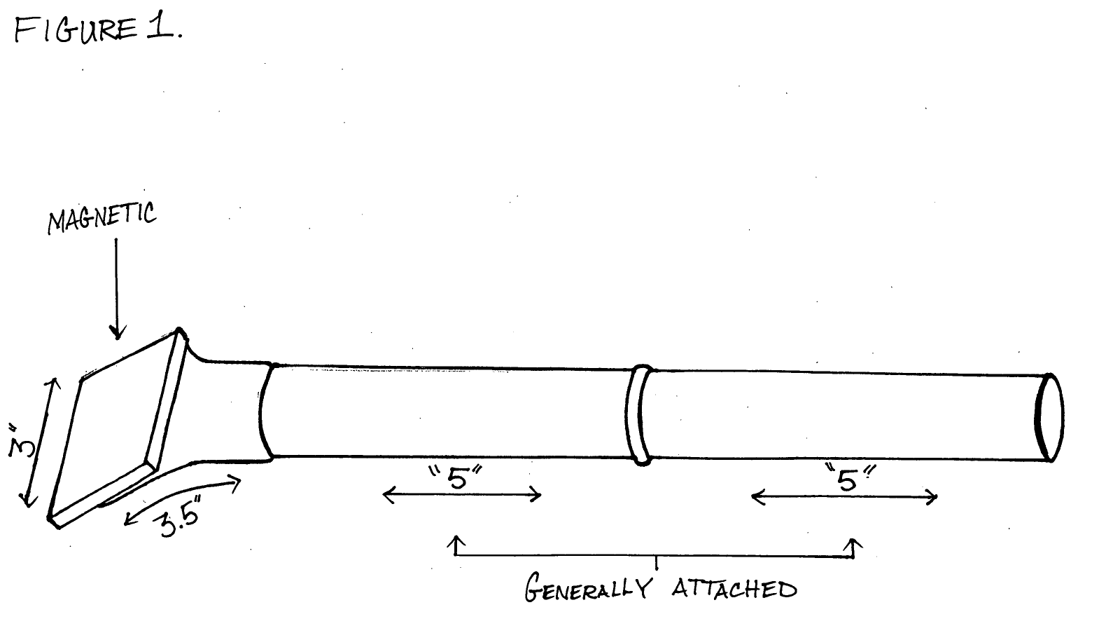

FIG. 1 Illustrates a set up of the complete assembly of this invention. Two attachment hoses preferably 1.5 ft each creating 3 ft of reach for uncomfortable work areas. Including and in place, the magnetic attachment, that consists of a hard plastic base with an opening that enables it to fit properly on the extension hose. Those with ordinary skill in the art will appreciate the set up of FIG. 1, may include even a fewer number in parts than shown in FIG. 1. Furthermore those with ordinary skill in art will understand that the set up may include additional components that are not shown and are not germane to the assembling of FIG. 1 in accordance with the invention arrangements.

Each part of this invention offers one or more advantages. The present invention provides a device to eliminate stress and strain created by excessive bending and or stooping to pick up small objects in the work force. The extension hoses provide length to reach under, over and around to gather objects. The magnetic head give way to the force needed to eliminate bending and/or stooping to reach. Thereby protecting the lower body, back and legs.

1. A magnetic devise used for picking up small objects, that are not within reach, or that would generally cause stress to the back and legs when reaching.
A magnetic pick up devise consisting of an elongated handle with two sections combined telescopic or screw.
A base that consist of a natural magnetic attachment with a 45% angle relative to the floor.
